(19) United States
(12) Patent Application Publication
(10) Pub. No.: US 2006/0030409 A1
(43) Pub. Date: Feb. 9, 2006

(54) Data management device within an electronic gaming device and a method for monitoring electronic gaming devices

(75) Inventors: Franz Lechner, Graz (AT); Helmut Steffenini, Graz (AT)

Correspondence Address: NIXON & VANDERHYE, PC, 901 NORTH GLEBE ROAD, 11TH FLOOR, ARLINGTON, VA, 22203, US

(73) Assignee: Systems in Progress Holding GmbH, Graz (AT)

(21) Appl. No.: 11/006,805

(22) Filed: Dec. 8, 2004

Related U.S. Application Data
(60) Provisional application No. 60/527,774, filed on Dec. 9, 2003.
(60) Provisional application No. 60/527,777, filed on Dec. 9, 2003.

(51) Int. Cl. A63F 9/24; G06F 19/00

(52) U.S. Cl. 463/42

(57) ABSTRACT

An electronic gaming system comprises a plurality of gaming devices (100a-100n) including respective data management devices (101a-101n) having a processor unit (102) for processing gaming data in the respective electronic gaming device (100a-100n) in response to a gaming sequence being performed using the electronic gaming device, a memory unit (103) for storing the gaming data generated in the electronic gaming device (100a-100n) and a communication device (104) for communicating gaming data with at least one other data management device, and a databus device (201) for connecting the plurality of data management devices (101a-101n) with each other through the communication devices (104) provided in each of the electronic gaming devices (100a-100n) for exchanging gaming data between the data management devices (101a-101n).

This application claims benefit and priority of U.S. Provisional Application Ser. No. 60/527,774 filed Dec. 9, 2003 and of U.S. Provisional Application Ser. No. 60/527,777 filed Dec. 9, 2003, and is related to simultaneously-filed U.S. patent application Ser. No. 10/______, (attorney docket: 2789-58) entitled “AN ELECTRONIC GAMING SYSTEM”, all the foregoing being incorporated herein by reference in their entirety.

### BACKGROUND

1. Field of the Invention

The present invention relates to an electronic gaming device, and in particular to an electronic gaming system comprising a plurality of data management devices interconnected by means of a databus.

2. Related Art and Other Considerations

A typical electronic gaming device is preferably electronic in design and operation and has only a few or no electromechanical or mechanical parts for operation. Furthermore, a typical gaming device can be cashless in operation and as such must accept electronic cards or tokens as wagers. An electronic gaming device may comprise an electronic token acceptor which is designed to accept designated tokens and reject others. Fund receivers of an electronic gaming device are designed such that a secure operation can be provided.

Preferably a computer connected to theelectronic gaming devices of an electronic gaming system is provided to control and monitor specific electronic gaming devices connected to the computer and to receive data from the electronic gaming devices.

The electronic gaming devices may comprise slot machines, a device interfacing card playing tables, roulette tables, dice tables, etc. The electronic gaming system which comprises a plurality of electronic gaming devices interconnected by means of a databus can be a part of a casino system.

PCT patent publication WO 0 230 532 discloses a method for operating a gaming device comprising at least one roulette basin having a roulette ball circulating therein, a sensor which is used to detect the movement of the ball, e.g. the speed or the duration of a revolution; a simulation means for calculating two characteristic moments of the games from the movement data of the moment when the roulette ball falls past a specific place and the moment when the roulette ball comes to rest in a field; a generating means used to determine at least one winning value and/or a joker symbol once a signal is received from the simulation means; a gaming value sensor which is used to detect the play value of the roulette basin; a comparison means for comparing the play value with the winning value and/or joker symbol; and, a control means which controls an optic and/or acoustic display in synchronization with the moments calculated by the simulation means and generates a signal corresponding to the result of the means of calculation. The corresponding method and a gaming device for carrying out that method are especially characterized in that the game becomes more attractive by synchronizing the display with the gaming process without forcing the player the change his or her gaming habits.

U.S. Pat. No. 4,283,709 describes a cash accounting and surveillance system for games whereby operation of a number of player operated gaming devices may be monitored for purposes of detecting abnormal operation and/or cheating and for providing automatic accounting information for record keeping and pilferage detection purposes. The system utilizes a node concept, with each node having a non-volatile data storage capability and a communications capability for communicating with each of a plurality of gaming devices coupled to the node. The exemplary embodiment operates in conjunction with slot machines having mechanically rotatable reels and a microprocessor control system for randomizing the reel stopping payouts and other machine functions.

Commonly used electronic gaming devices are connected by a network, e.g. a computer network. The network connection provides many advantages such as the ability to gather gaming data for accounting from the individual gaming devices. Data collection systems are commonly known (e.g. described in U.S. Pat. No. 4,283,709) and provide an operator of an electronic gaming system with the capability to monitor the usage and payouts, collectively known as audit data. This audit data includes data related to the money (cash and cashless) played, the number of times the device has been played, the amount paid in raises, the number and type of the jackpots paid by the machine, the number of door openings, etc. The operator is able to compile an accounting report based on the audit data from each of the electronic gaming devices.

Another advantage of the connection of electronic gaming devices via a computer network is the usage of the audit data for marketing purposes. Marketing and management of electronic gaming devices is based on the provision of statistical data of specific electronic gaming devices, e.g. slot machines. Thus the data have to be collected in regular periods, have to be stored, processed and optionally displayed. If a network is provided, the operator can easily operate the operation of the specific electronic gaming devices from a remote location.

In order to implement jackpot gaming systems, the electronic gaming devices have to be interconnected via a computer network to attract the players' interest. A relatively large number of different jackpot and bonus systems implemented requires data management to handle and operate these systems.

For example, data used for the above mentioned purposes usually are generated in various acceptors and meters (e.g. coin acceptor, bill acceptor, . . . ) whereas additional data are collected from door openings, hand payouts, jackpot payouts, display systems etc.

It is necessary that most of the data be collected, stored, processed and explored. This is why data have to be communicated from the location where they are generated to the location where they can be processed and have to be provided for the operator. Such a data management and communication require stable data management systems.

FIG. 3 illustrates a conventional electronic gaming system. A number n of electronic gaming devices 301a-301n are connected via a communication network device 309. Data from particular electronic gaming devices 301a-301n are transferred to and stored in a central database 304 which is usually provided twice (for, e.g., redundancy). A floor server 401, usually provided redundantly, connecting the central database 304 with the communication network device 309. A computer 308, e.g. a workstation for configuration purposes, is connected to the central database 304. The floor server 401 comprises a data concentrator for concentrating data and three operating servers 305, 306 and 307 serving, e.g. as an accounting server 305, a clearance server 306 and a journal server 307, respectively. Furthermore, a display controller 311 is connected to the communication network device 309 for displaying gaming data at a display device 310.

Each of the electronic gaming devices 301a-301n comprises an interface controller 302a-302n for communicating data to and from the communication network device 309. In the conventional electronic gaming system shown in FIG. 3 gaming data are forwarded to a central database 304. The electronic gaming devices 301a-301n each communicate (via the interface controller 302a-302n) with a casino operator, a control processor unit for the electronic gaming device, a data concentrator, and a propriety user interface to export the data.

It is thus a major disadvantage of a conventional electronic gaming system that at least three independent communication interfaces have to be provided, and that in case of total redundancy each communication interface has to be built up twice for each electronic gaming device, because each communication interface is to be regarded as a source of failure. In case of a breakdown of a singular communication interface device the data management system becomes instable. Thus, each single failure can destroy a secure communication between the operator and a specific electronic gaming device.

### BRIEF SUMMARY

It is thus an object to provide an electronic gaming system having reduced failure rates and performing an improved, stable operation.

A data management device within an electronic gaming device has a processor unit for processing gaming data and a memory unit for storing gaming data, wherein a communication device for communicating gaming data with at least one other data management device included in the other electronic gaming device. Gaming data of another electronic gaming device can be stored in the memory unit of the data management device by means of the processor unit, Furthermore, the processor unit for processing gaming data is adapted for processing gaming data stored in the memory unit, Thus, a data management system is advantageously simplified by storing gaming data not at a central database as in conventional electronic gaming systems but at each of the data management devices within the electronic gaming devices. Advantageously a data management is provided which permits identical data to be stored in the respective memory units of the electronic gaming devices interconnected in an electronic gaming system. Furthermore, it is preferred that the memory units of the data management devices are arranged such that gaming data can be multiply stored in the electronic gaming system.

According to an aspect, the gaming data comprise one or more of audit data, door opening data, payout data, jackpot payout data, cashflow data, number of games data, identification data, position related data, jackpot configuration data, site configuration data and system related data. The gaming data comprise static and/or dynamic data and/or other treated data wherein the static data include one or more of position related data, parameters of the electronic gaming device, denomination data maximum-bet data, payout percentage data, serial numbers, game identification data, pay table identification data, bill country and game number data, whereas the dynamic data comprise one or more of site configuration data, jackpot configuration data and audit data.

According to another aspect, the communication device of the data management device within an electronic gaming device comprises an output unit for outputting gaming data to an external device. Preferably the external device is another electronic gaming device of a network of interconnected data management devices within electronic gaming devices of an electronic gaming system.

Furthermore, the communication device of the data management device within an electronic gaming device comprises an input unit for inputting control data and external data from the external device such that these data can be transferred to and stored in the memory unit by means of the processor unit. As gaming data are processed in a specific data management device within the electronic gaming device and external data from another data management device within the other electronic gaming device can be stored in the memory unit of the data management device within the electronic gaming device, the gaming data may be plurally stored in a series of data management devices within electronic gaming devices such that a redundancy of storing the relevant gaming data is provided. The communication device for communicating gaming data with at least one other data management device within the other electronic gaming device of the electronic gaming system can comprise serial interfaces for a connection to the electronic gaming device.

The electronic gaming system comprises a plurality of gaming devices each comprising a data management device, including a processor unit for processing gaming data generated in the respective electronic gaming device in response to a gaming sequence being performed using the electronic gaming device, a memory unit for storing gaming data generated in the gaming device, by means of the processor unit; and a communication device for communicating gaming data with at least one other data management device within the other electronic gaming device of said electronic gaming system, and a data bus device for connecting the plurality of data management devices with each other by means of the communication devices provided in each of the data management devices within the electronic gaming devices for exchanging gaming data between said data management devices within the electronic gaming devices of said electronic gaming system.

According to yet another aspect, the memory units of the data management devices within electronic gaming devices are designed such that the data can be multiply stored in the electronic gaming system.

According to yet another aspect, the data bus device for connecting said plurality of data management devices by means of communication devices is provided as a one to many communication device, e.g. 100 BaseTBus.

According to yet another aspect, the memory units of the data management devices within the electronic gaming devices are designed to store identical data.

Preferably, the databus device is provided as an Ethernet connection.

It is preferred that an operator terminal is provided and connected to the databus device for controlling and monitoring one or more of the electronic gaming devices interconnected in an electronic gaming system.

Preferably, the electronic gaming devices of said electronic gaming system each include a human interface unit comprising a display unit for displaying gaming data, a player identification unit for gathering player related information, an input unit for communication purpose between the player and the electronic gaming system and other peripheral devices.

According to yet another aspect, the databus device for connecting the plurality of data management devices with each other by means of the communication devices provided in each of the electronic gaming devices is formed by an internet connection.

A method for controlling and monitoring an electronic gaming device of a network of interconnected data management devices within the electronic gaming devices of an electronic gaming system comprises the steps of processing gaming data generated in the electronic gaming device in response to a game sequence being formed using the gaming device by means of a processor unit provided in the data management device within the electronic gaming device; and storing of gaming data generated in the electronic gaming device in a memory unit provided in the data management device within the electronic gaming device, by means of the processor unit, wherein gaming data are communicated with at least one other data management device within the other electronic gaming device of the electronic gaming system by means of a communication device provided in the data management device within the electronic gaming device, wherein the gaming data of the other electronic gaming device are stored in the memory unit of the data management device by means of the processor unit, and wherein gaming data stored in said memory unit are processed by the processor unit of the data management device within the electronic gaming device.

According to yet another aspect, statistical data are generated using the gaming data output from the plurality of electronic gaming devices.

According to yet another aspect, a data management is performed using the processor unit, the communication device and the memory unit of a data management device within an electronic gaming device such that gaming data stored in the memory units can be processed.

It is preferred that the data management comprises a protocol detection step for detecting protocols generated by the electronic gaming devices. More preferably the data management periodically synchronizes and/or updates the data stored in the memory units of the data management device within the electronic gaming devices.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention

FIG. 1 is a schematic view of a data management device within an electronic gaming device according to an example embodiment.

FIG. 2 is a schematic of an electronic gaming system comprising a plurality of data management devices within electronic gaming devices interconnected by means of a databus, according to an example embodiment.

FIG. 3 is a schematic view of a conventional electronic gaming system having electronic gaming devices.

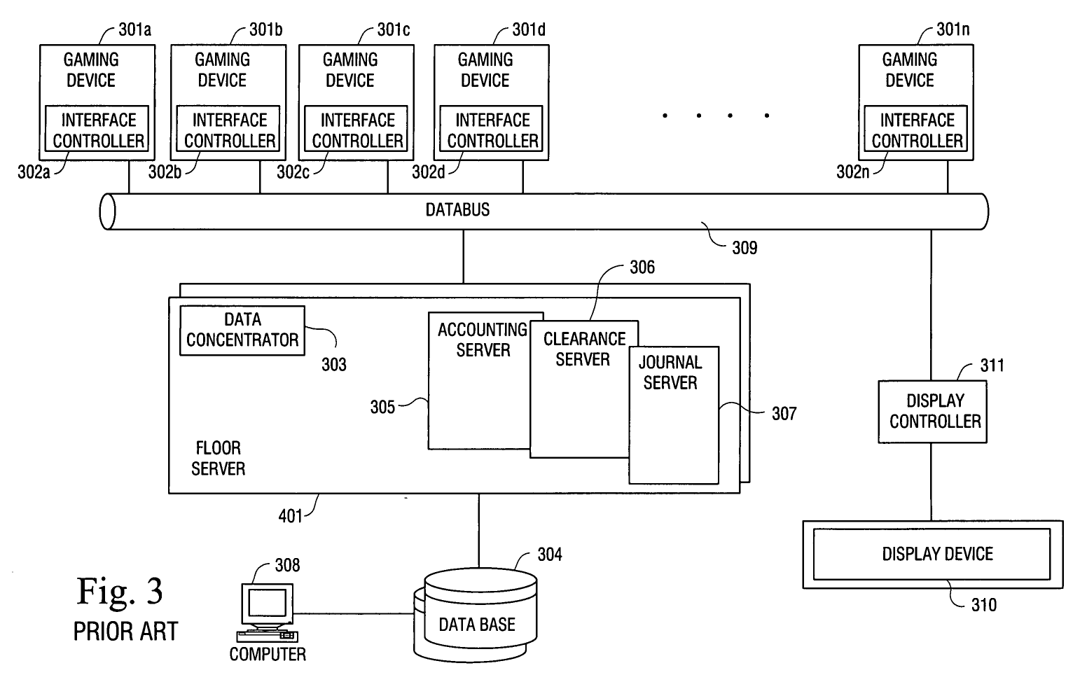

### DETAILED DESCRIPTION

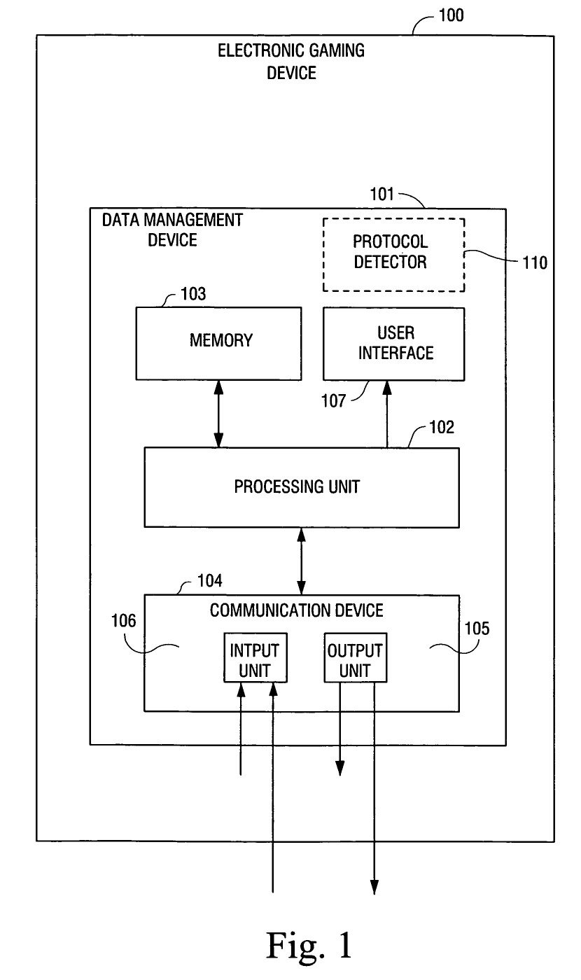

FIG. 1 exhibits a schematic block diagram of an electronic gaming device 100 according to an example embodiment. The electronic gaming device 100 of FIG. 1 comprises a data management device 100, which in turn comprises processor unit 102.

The processor unit 102 is connected to a memory unit 103 and (optionally) to a user (human, e.g., player) interface unit 107. The user interface 107 comprises one or more of a display unit for displaying gaming data, a player identification unit for gathering player related information, an input unit for communication purpose between the player and the electronic gaming system, and other peripheral devices. The processor unit 102 is adapted to store gaming data into the memory unit 103 and to read gaming data from the memory unit 103.

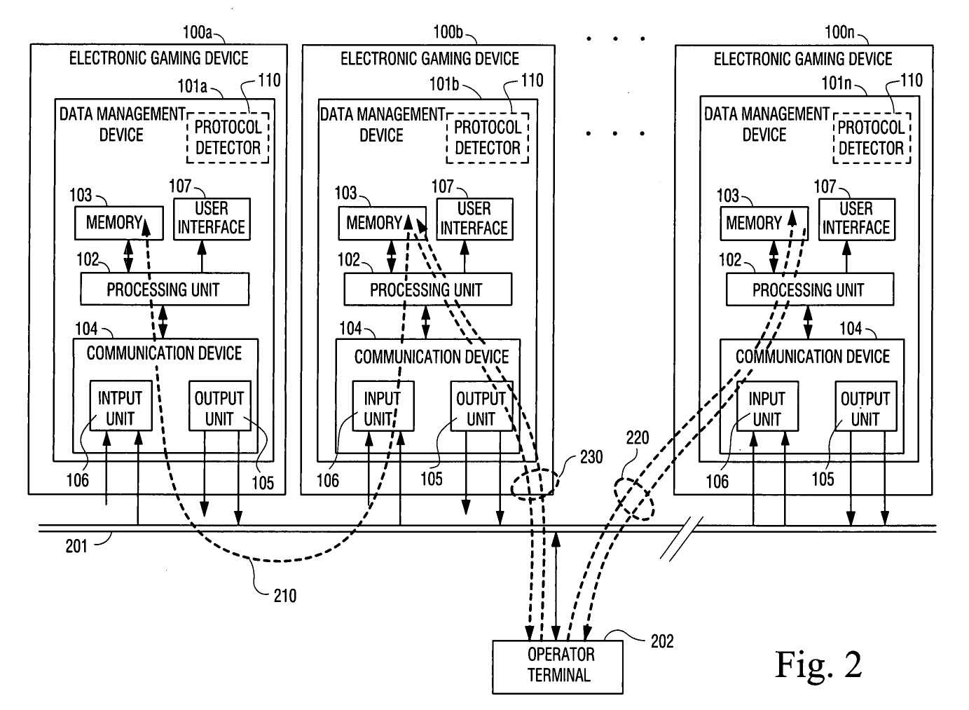

Furthermore, the processor unit 102 is connected to a communication device 104 which is designed for communicating gaming data with at least one other data management device within the other electronic gaming device connected to an electronic gaming system. The data management device 101 within the electronic gaming device 100 is one of a network of interconnected data management devices 101a-101n within electronic gaming devices 100a-100n (to be described with reference to FIG. 2) of the electronic gaming system. The communication device 104 essentially compriese an output unit 105 and an input unit 106. The output unit 105 outputs gaming data to an external device, e.g. to another data management device 101a-101n within the other electronic gaming devices 100a-100n of the electronic gaming system. The input unit 106 inputs control data and external data from the external device (e.g. from another data management device 101a-101n) such that these data can be transferred to and stored in the memory unit 103 by means of the processor unit 102.

Furthermore, it is possible to provide serial or parallel interfaces for the connection of the communication device 104 and a corresponding electronic gaming device 100 and a one to many communication to the databus device 201 (FIG. 2). In an example embodiment all data management devices 101a-101n within electronic gaming devices 100a-100n include a communication device 104 such that they are able to communicate via serial connections of some type using a protocol of some type typical for a brand of an electronic gaming device (e.g. a slot accounting system; SAS protocol). In the example embodiment the communication device 104 is located within the data management device (i.e. the slot machine interface board) which basically provides the interface between the electronic gaming device and the operator.

FIG. 2 illustrates an example embodiment of an electronic gaming system comprising a plurality of data management device 101a-101n within electronic gaming devices 100a-100n interconnected by means of a databus device 201. Furthermore, FIG. 2 shows an operator terminal 202 which is provided for an operator to control and monitor one or more of the electronic gaming devices 100a-100n. Furthermore, it is possible to provide an interface for the connection of the communication device 104 and a databus device 201 (FIG. 2).

In an example embodiment all electronic gaming devices 100a-100n include data management device (i.e. the slot machine interface board) 101a-101n, including a communication device 104 such that they are able to communicate with each other. In the preferred embodiment a data management device 101 is located within the electronic gaming device and basically provides the interface between the electronic gaining device and the operator.

Gaming data relevant to control, to operate, and to monitor the electronic gaming devices 100a-100n are communicated to the specific communication device 104 of data management device 101a-101n. Gaming data from one electronic gaming device 100a thus may be transferred to one or more of the remaining data management devices 101b-101n within the remaining electronic gaming devices 100b-100n via the communication devices 104. The respective processor unit 102 of a data management device is able to transfer external data from other data management devices 101b-101n within other electronic gaming devices 100b-100n to the memory unit 103 of the data management device 101a.

In an example embodiment a data management system periodically synchronizes the data stored in the memory units 103 of the data management devices 101a-101n in order to ensure that the data in the respective memory units 103 of the data management devices 101a-101n are consistent data. Preferably all the gaming data stored in one data management device 101a of one electronic gaming device 100a are transferred to all other data management devices 101b-101n in all other electronic gaming devices 100b-100n.

The databus device 201 connecting the plurality of data management device 101a-101n in the electronic gaming devices 100a-100n by means of communication devices 104 may be provided as a one to many communication. Furthermore, it is possible to provide the databus device 201 as a 100BaseTBus or as a one-to-many communication, e.g., TCP/IP. Furthermore, it is possible to provide the databus device 201 as an Ethernet/or Internet connection.

The gaming data exchanged between the data management devices 101a-101n within the electronic gaming devices 100a-100n roughly can be divided into two different groups: (i) static data; and (ii) dynamic data.

The static data are data that are strictly correlated to the data management devices 101a-101n of a respective electronic gaming device 100a-100n. The static data cannot be changed and are not suited for data processing in another data management device 101a-101n. Thus, the static data specifically correspond to one single data management device 101a-101n.

The static data comprise position identification data, parameter data (parameters of the electronic gaming device); and, automatic parameter data. The position identification data can be a position identifier and thus can be equivalent, for example, to an IP address of the data management device 101a-101n. In an example embodiment the position identifier may be alphanumeric. Furthermore the position identifier can be a function of different groupings as there may be, e.g., bank, area, site name, game, etc. or a combination of these. Furthermore the position identifier can be the IP Address of the electronic gaming device in the network.

The parameter data of an electronic gaming device 100a-100n are manually input into the data management device 101a-101n. The electronic gaming device 100a-100n does not provide any information about these data via a protocol. Examples for these data are inventory numbers, manufacturer names, model names, cabinet style, etc.

The automatic parameter data for electronic gaming devices 100a-100n are communicated from the electronic gaming device automatically via a protocol. Examples for these data comprise denomination data defining—the relation between currency units and gaming units, maximum-bet data defining a possible maximum bet during a game sequence, payout percentage data, serial number data, game identification data, pay table identification data, bill country code data, data relating to the number of games implemented, etc.

The above mentioned dynamic data comprise data which are communicated from one electronic gaming device 100a-100n to the data management device 101a-101n and to the other data management devices 101a-101n, these data being transferred by each communication device 104.

The dynamic data comprise: site configuration data; jackpot configuration data; and audit data. The site configuration data defines the characteristics of the site and operation characteristics; for example, these data include a site name, a site short name, a day closing period, a clearance period, etc.

The jackpot configuration data includes all data required to define jackpot systems, e.g, jackpot name data, jackpot type data, jackpot parameter data, etc. The audit data are related to a respective gaming sequence performed at the electronic gaming device and which are related to in situ maintenance data. These data are generated by the specific electronic gaming devices 100a-100n. These data include, for example, the amount of funds (cash and cashless) being wagered, the number of times the electronic gaming device 100a-100n has been used, the number and type of the jackpots played by the electronic gaming device, the number of door openings, etc.

An example, representative procedure for exchanging data between the data management devices 101a-101n via the databus device 201 is described below.

When an electronic gaming system with its respective data management devices 101a-101n and its communication devices 104 is set up, the operator initially assigns identification data and configuration data to each data management device 101a-101n. These data comprise static data and initial dynamic data. The operator utilizes a standard web browser to assign all required information to the respective data management devices 101a-101n by the means of the communication devices 104.

The operator assigns static data comprising the position identification data of a specified data management device 101a-101n at a specified location. In the electronic gaming system the position number (position identifier) of a data management device 101a-101n including a communication device 104 can be used as the IP address of the data management device 101a-101n. Furthermore, the user assigns the parameter data of the electronic gaming device.

The automatic parameter data of the electronic gaming devices are communicated automatically by the electronic gaming devices 100a-100n to the respective data management device 101a-101n via the respective communication devices 104. It is possible that different manufacturers of electronic gaming devices utilize different protocols for a communication. Therefore, the data management device 101 comprising the communication device 104 has a protocol detector 110 which starts an automated scanning procedure with the purpose to identify the protocol of the electronic gaming device. The data management device 101 comprising the communication device 104 is capable of automatically identifying protocols of most of the relevant brands of electronic gaming devices 100a-100n.

For assigning the initial dynamic data the operator connects a specific data management device 101a-101n to the databus device 201. The identification of the communication device 104 of the data management device 101a-101n to be connected is performed by entering the IP address and/or the position identification data.

The data management device 101 comprising the communication device 104 being automatically connected obtains a server function for a specific data set. This means that the data management device 101 having the server function transfers required data to any other data management device 101a-101n if requested unless the server function is switched off due to a failure or due a removal of the specific data management device 101a-101n or the specific electronic gaming device 100a-100n. In this case a specified procedure starts to determine a new data management device 101 of another electronic gaming device 100a-100n for getting the server function to correlate the specific dataset.

During an operation of the electronic gaming devices 100a-100n comprising the data management devices 101a-101n connected by the databus device 201 audit data are related to the gaming sequence, i.e. meter readings, gaming data and jackpot data and furthermore are related to the maintenance of the electronic gaming device, e.g. door openings. Those data are communicated from the electronic gaming device to the communication device 104 of the data management device 101a-101n via a protocol. Each data management device 101a-101n processes, stores and transfers audit data in regular time intervals.

Furthermore, audit data may be transferred to the operator terminal 202 when requested. As the audit data are transferred to the databus device 201 it is possible to display relevant data at a display system preferably comprising a data management device comprising a communication device and a display device (not shown).

Furthermore, data may be processed in each data management device 101a-101n by means of a respective processor unit 102. Thus, the processor unit 102 is designed to handle various jackpot data as defined by the operator.

The electronic gaming system according to an example embodiment comprising a plurality of data management devices 101a-101n within electronic gaming devices 100a-100n permits gaming sequences to be performed using a jackpot system.

The data management device 101a-101n within an electronic gaming device 100a-100n of an example embodiment comprises a processor board, Ethernet PHY and RJ45 Ethernet connector and a real time clock, a power supply connector, three connectors for serial communications, an I2C bus having connectors for I2C off-board connections and headers for on-board I2C devices which can also be used as an additional power supply for SPI expansions and connectors which are multiplexed with an I2C multiplexer chip to allow different speeds on different boards as well as to manage the capacitance issue of the I2C bus.

The following table 1 summarizes the specific connectors associated with a data management device 101.

TABLE 1

| J | Connector |
|---|---|
| J1 | Power |
| J2 | Network |
| J3 | Electronic gaming device-Interface |
| J4 | General purpose serial IO1 |
| J5 | General purpose serial IO2 |
| J6 | Doors |
| J7 | Flash |
| J8 | Expansion 1 |
| J9 | I2C-1 |
| J10 | 12C-2 |
| J11 | I2C-3 Position Identification |
| J12 | I2C-I1 IO Expansion |
| J13 | 12C-I2 Clearance Trigger |
| J14 | 12C-I3 Tamper Switch |

A few comments are provided bewlo for specific connectors for an example, non-limiting implementation. It should be understood other types of connectors can be utilized in other embodiments.

The power supply for the J1 power connector ranges from 5VDC 24VDC. The J2 network connector is a data management device to the databus device.

The J3-SM Interface connector is either directly or indirectly, via back panel, connected to a CPU board of a respective electronic gaming device 101. This connector may have several levels, such as RS232 and current loop via external converter. Protocols to be handled include the following: SAS; MS10; Grips; ASP. A parallel machine will be connected through an external parallel/serial converter, which will convert the parallel machine signals into SAS-protocol.

Concerning the J4 General purpose serial IO1 connector, all serial I/Os have the same type of connector and are on RS232. Level SIO1 is provided for in-machine display; serial return; and for other purposes.

The J5 General purpose serial IO2 connector be used for connection to any other device (e.g., in machine display, serial return, and others).

Concerning the J6 Main-Door connector, the data management device main board has only one door connector (switch-over contact) to monitor the machine main door. Any other doors will be connected to a door expansion module connected to any I2C port. This door expansion module may be in different variations to fulfill different levels of requirements on number of doors as well as on security of door surveillance. Such doors may be: a bill door; a logic door; or a door connector on the top box or elsewhere.

The J7 Flash Memory connector is for a removable flash memory expansion for non volatile data storage. The flash memory is plugged directly on the data management device board.

With the J8 Expansion Interface for high speed IO (serial port), additional modules for later expansion can be connected to realize, e.g., the following: Graphic display, card reader, keyboard Sound (MP3).

Concerning the J9 Interface to Position-ID connector, there are additional I2C-interfaces, with the same type of connector and same pin-out. These I2C-ports are interchangeable, whereby the first one is by default assigned for the connection to the Position Identification (PID) module. On the PID-module the Position-ID is written during setup of the machine base. Also on the PID-module it is possible to connect the cashbox door switch.

The J10 Optional inputs/outputs via I2C connector can connect additional IO's like additional door contacts, machine lockout, etc.

The J11 connector allows for optional inputs/outputs via I2C. This port is provided for a connection of one of the following items: push buttons or key-switches and LED's for clearance activation; or simple player insert with display, keyboard and means of player identification (with feed-through connection).

Concerning the J12, J13 onboard I2C, there are 2 I2C-port for add-on devices plugged directly onto the board. The following are exemplary extensions: an optional tamper switch, power supply in combination with the SPI ports, etc.

The flash memory module holds permanent data.

The electronic gaming system according to an example embodiment thus being described, a skilled person will recognize that it is a major advantage that gaming data are being stored where they are generated and processed. The operator terminal 202 is only required in such cases where an operator wishes to control and monitor specific electronic gaming devices 100a-100n.

Furthermore, it is an advantage that a stable operation of the electronic gaming system can be provided even if one or more of the electronic gaming devices 100a-100n has a failure. Due to the redundancy of gaming data storage in a plurality of data management device 101a-101n within electronic gaming devices 100a-100n of the electronic gaming system an improved operation having reduced failure rates is obtained.

A further advantage is provision of “hopping” server function, which means that all data management devices within the electronic gaming system are equal. Accordingly, if a server function cannot be provided due to failure or a removal of a specific data management device within the electronic gaming device, then another data management device within the other electronic gaming device provides the server function.

Furthermore, it is an advantage that gaming data is plurally provided in each of the data management devices within the electronic gaming devices to provide a n-times redundancy.

As the gaming data are stored within the electronic gaming system in each of the data management devices within the electronic gaming devices a central database is not required.

Furthermore, each data management device comprises an automatic protocol detection unit for the detection of different protocols which are typical for a manufacturer of an electronic gaming device. This results in the advantage that a data management device is capable of automatically exchanging data with any electronic gaming device, as depicted by broken line 210 in FIG. 2. It is thus an advantage that a casino operator does not have to identify the specific protocol types provided by the electronic gaming devices.

Another advantage is that gaming data are processed at the location of each electronic gaming device of the electronic gaming system. This means that data are processed at a location where they are generated. Thus, the operator can request the data directly either from a specific data management device (as depicted by broken lines 220 in FIG. 2) or another data management device (as depicted by lines 230 in FIG. 2) within the other electronic gaming device can request data from the specific data management device.

Gaming data do not have to be communicated to a central location for processing and thus do not have to be communicated back to the electronic gaming device resulting in reduced data rates in a databus device connecting the electronic gaming devices of the electronic gaming system. Due to reduced communication requirements less computing power is required.

Yet another advantage is that a redundancy is provided concerning the data storage of gaming data and that gaming data may be processed at the location of a specific data management device within the electronic gaming device. Furthermore it is an advantage that less communication interfaces have to be actuated when gaming data are transferred and/or stored. Furthermore, it is an advantage that a processing speed due to a combination of data management devices within electronic gaming devices may be increased.

The redundancy of the electronic gaming system is large, because the gaming data are stored in each of the data management device within the electronic gaming devices and transferred to the remaining data management devices. Thus, an electronic gaming device having a failure is prevented from becoming an obstacle to the whole electronic gaming system. Furthermore, it is an advantage that no additional propriety client software is necessary for processing the relevant gaming data. Moreover, it is an advantage that the automated transfer of relevant information from one data management device within the electronic gaming device to another may be provided (again depicted by lines 210 in FIG. 2). Furthermore, no multilayer communication path is required as only a single point communication between a data management device and an operator exists.

Furthermore, it is an advantage that a simplified software maintenance is provided. Furthermore, an installation procedure may be performed in a simple manner as no server installation and no central database installation requiring separate setup and tuning implementations are necessary.

Moreover it is an advantage that an easy hardware maintenance due to a simple exchange of hardware components receiving configuration data automatically from another data management device within the other electronic gaming device connected to the network can be provided. Furthermore, it is preferred that the usage of an internet connection which allows an access to site data (casino/location data) can be provided.

The electronic gaming system of a network of interconnected data management devices within the electronic gaming devices of an electronic gaming system comprises a processor unit for processing gaming data generated in the gaming device in response to the game being played using the electronic gaming device and a memory unit for storing gaming data generated in the gaming device, by means of the processor unit, wherein a communication device communicating game data with the correlating electronic gaming device and at least one other electronic game device of said electronic gaming system is provided, and wherein said gaming data of said other electronic gaming device are stored in the memory unit of the data management device within the electronic gaming device by means of the processor unit, and wherein the processor unit for processing gaming data, is adapted for processing gaming data stored in that memory unit.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

Accordingly it is to be understood that the present invention has been described by way of illustration and not limitation.

Furthermore the invention is not limited to the specific application areas mentioned above.

What is claimed is:

1. A data management device for use in an electronic gaming device of a network of interconnected data management devices of an electronic gaming system, comprising:
a processor unit for processing gaming data generated in the gaming device in response to a gaming sequence performed using the electronic gaming device;
a memory unit for storing the gaming data generated in the gaming device;
a communication device which facilitates communication of data between the data management device and at least one other data management device within another electronic gaming device of said electronic gaming system;
wherein said gaming data of said another electronic gaming device are stored in the memory unit of the data management device; and
wherein the processor unit for processing gaming data is adapted for processing the gaming data stored in said memory unit.

2. A device according to claim 1, wherein the gaming data comprise one or more of audit data, door opening data, hand payout data, jackpot payout data, cash flow data, number of games data, identification data, position related data, jackpot configuration data, site configuration data and system related data.

3. A device according to claim 1, wherein the gaming data comprise static data and/or dynamic data as well as any other treated data in the electronic gaming system.

4. A device according to claim 3, wherein the gaming data comprise static data including one or more of position related data, parameters of the electronic gaming device, denomination data, maximum-bet data, payout percentage data, serial numbers, game identification data, paytable identification data, bill country and game number data.

5. A device according to claim 3, wherein the gaming data comprise dynamic data including one or more of site configuration data, jackpot configuration data, and audit data.

6. A device according to claim 1, wherein the communication device comprises an output unit for outputting gaming data to an external device.

7. A device according to claim 1, wherein the communication device comprises an input unit for inputting control data and external data from the external device such that the control data and the external data can be transferred to and stored in the memory unit by means of the processor unit.

8. A device according to claim 1, wherein the communication device for communicating gaming data with the electronic gaming device it is located in comprises at least one serial interface.

9. A device according to claim 1, wherein the processor unit is able to handle gaming data generated in an additional and/or external system.

10. A device according to claim 1, wherein the electronic gaming device is one of a slot machine, a game-featuring device, or a device which interfaces to a gaming table.

11. A device according to claim 10, wherein the game-featuring device is one of electronic roulette, electronic Black Jack, electronic Bingo.

12. A device according to claim 10, wherein the device which interfaces to a gaming table interfaces to one of a card playing table, a roulette table, and a dice table.

13. An electronic gaming system, comprising:
a plurality of gaming devices each including a data management device having:
a processor unit for processing gaming data generated in the respective electronic gaming device in response to a gaming sequence performed using the electronic gaming device;
a memory unit for storing the gaming data generated in the gaming device
a communication device for communicating with at least one other data management device within another electronic gaming device of said electronic gaming system; and
a data bus device for connecting the communication devices of the plurality of data management devices, the data bus device serving for exchanging gaming data between said data management devices provided in the electronic gaming devices of said electronic gaming system.

14. A system according to claim 13, wherein the memory units of the data management devices designed such that the data can be multiply stored in the electronic gaming system.

15. A system according to claim 13, wherein the databus device for connecting said plurality of data management devices by means of communication devices is provided as a one-to-many communication.

16. A system according to claim 13, wherein the memory units of the data management system are designed to store identical data.

17. A system according to claim 13, wherein the databus device is provided as an Ethernet connection.

18. A system according to claim 13, wherein an operator terminal is provided and connected to the databus device for controlling and monitoring one or more of said data management devices.

19. A system according to claim 13, wherein the data management devices of the electronic gaming system each comprise a user interface unit.

20. A system according to claim 19, wherein the user interface comprises a display system for displaying gaming data.

21. A system according to claim 19, wherein the user interface comprises a player identification unit for collecting player related data.

22. A system according to claim 13, wherein the databus device for connecting the plurality of data management devices with each other by means of the communication devices provided in each of the data management devices is formed by an Internet connection.

23. A method for controlling and monitoring electronic gaming devices of an electronic gaming system using a network of interconnected data management devices provided in the electronic gaming devices, the method comprising:
processing, with a processor unit provided in the data management device, gaming data generated in the electronic gaming device in response to a gaming sequence being performed using the gaming device storing the gaming data generated in the electronic gaming device in a memory unit provided in the data management device;
communicating gaming data with at least one other data management device provided in another electronic gaming device of said electronic gaming system; and
also string the gaming data of said electronic gaming device in the memory unit of the data management device of the another electronic gaming device.

24. A method according to claim 23, further comprising processing the gaming data stored in said memory unit using the processor unit of the data management device.

25. A method according to claim 23, wherein statistical data are generated using the gaming data output from the plurality of electronic gaming devices.

26. A method according to claim 23, wherein a data management is performed using the processor unit, the communication device and the memory unit of a data management device such that gaming data stored in the memory units can be processed.

27. A method according to claim 26, wherein the data management device comprises a protocol detection for detecting protocols generated by the gaming devices.

28. A method according to claim 23, wherein the data management device periodically synchronizes and/or updates data stored in said memory units of said data management device.
